(19) United States
(12) Patent Application Publication
(10) Pub. No.: US 2010/0287147 A1
(43) Pub. Date: Nov. 11, 2010

(54) METHOD FOR PRODUCING DOCUMENTS

(75) Inventors: Peter Werkander, Huddinge (SE); Thomas Werkander, Huddinge (SE)

Correspondence Address: YOUNG & THOMPSON, 209 Madison Street, Suite 500, Alexandria, VA, 22314, US

(73) Assignee: STROMBERG DISTRIBUTION AB, Stockholm (SE)

(21) Appl. No.: 12/812,082

(22) PCT Filed: Feb. 11, 2009
(86) PCT No.: PCT/SE09/50149

§ 371 Date: Jul. 23, 2010

(30) Foreign Application Priority Data
Feb. 11, 2008 (SE) 0800302-2

(51) Int. Cl. G06F 17/00; G06F 17/30; G06F 15/16

(52) U.S. Cl. 707/705; 715/234; 707/E17.005

(57) ABSTRACT

Method for the automatic production of documents, where each single document is intended for communication from a sender to one of a multiplicity of recipients and is built up from at least one module, each module including at least one of a variable field and a static field, at least one module including a variable field, one or several, interconnected computers including a digitally stored sender database including a post for each possible sender; a digitally stored recipient database including a post for each possible recipient; a digitally stored content database including at least one module and at least one field; a digitally stored rule database including at least one rule which at least indicates a part of the contents of the finished document based upon a certain combination of, and information included in, a sender post and a recipient post, respectively; a document assembly unit, which produces a certain document for a certain combination of a sender post and a recipient post based upon the rules; and a control unit for controlling the document assembly unit. The rule database includes at least one module rule, which, based upon at least one of firstly the combination of, and secondly information included in, the certain posts, indicates whether a specified module is to be included in the finished document, and at least one field rule, which indicates whether a specified field is to be included in the specified module, and the document assembly unit produces each document as a concatenation of at least one module.

The present invention relates to a method for producing documents. More specifically, the invention relates to a method for producing documents where each document is intended to be communicated from a sender to a recipient.

It is common practice that manufacturers, businesses, etc. produce series of communications, where each communication is intended to be sent to one of a multiplicity of recipients, for example a certain selection of the customers, suppliers or business partners of the business. This may be the case regarding advertising, informative letters concerning aftermarket sales, and so on. The communications may need to be produced in a plurality of different formats, such as printed brochures or letters, e-mails, SMS or MMS messages, or in other formats.

A number of problems are related to the conventional production of such series of communications.

Firstly, for each series of communications, a relevant selection of the group of recipients at hand must be made, in order to avoid that communications unnecessarily reach recipients that are not concerned. Today, such a selection must be made at least to some extent manually for each type of communication, possibly by indicating a selection which has been effected beforehand to be used for a certain communication. The selection is often based upon an existing address register in digital or analogoue format, which implies that when recipient addresses are altered, added or removed from the address register, any selection already carried out must be updated taking these changes into account.

Secondly, in many cases one must at least partly tailor communications to the specific properties of the recipient. For example, it is common for a sender to wish the name of the recipient to appear in a letter head, in order to give the letter a more personal touch. In addition, it is common practice that various numerical data, such as account balance or current bonus amount, is stated in a communication. Such individual adaptations are typically effected by using a common template document, containing one or several variable fields. Each such field is filled out using individualised information, such as name, during the creation of the document for a certain recipient. However, such a method requires the common template document in its entirety to be relevant for the whole intended circle of recipients.

Thirdly, in many cases it is desirable to send communications to a certain group of recipients, where in addition the sender is not the same for different recipients. Such may for example be the case when a business is represented by a number of local offices, and where a mass communication to the customers of the business is to be individualised so that the sender is the local office of each customer. By way of example, this is often desirable in the case of banks and petrol stations.

Fourtly, there is a demand for updating or altering the static contents of used template documents every now and then. In many cases, this involves having to update or alter more than one template document.

To sum up, experience proves that the complexity, and therefor the cost, for the administration and use of a method for sending individualised documents from sender to recipient grows exponentially as the number of different circles of recipients and the number of senders increase, which in turn heavily hampers the possibilities to create relevant, individualised documents.

In order to solve this problem, relatively broadly formulated template documents are in many cases used. This makes every template document usable for as broad a circle of recipients as possible, and at the same time avoids that a large amount of template documents exists that need to be administered. On the other hand, it leads to poor precision when it comes to communiction using the created documents.

Another problem arises for example when a business orders an external part to take care of certain recipient adapted mass communications on account of the business. In this case, there is little possiblity for the business to affect the end result for the business, above and beyond the instructions that are given to the external part, since it is time consuming and costly to produce template documents, that once produced may be altered employing merely a certain minimum amount of work, something which in most cases also demands specialty competence in general not posessed by the business.

The present invention solves the above described problems.

Thus, the invention relates to a method for the automatic production of a multiplicity of documents, where each single document is intended to be communicated from a sender to one of a multiplicity of recipients and where the contents of the document comprise data from a digitally stored content database caused to comprise modules and fields, and where the contents of the document furthermore are specifically adapted to information which is stored in a certain post corresonding to the sender in a digitally stored sender database and to information which is stored in a certain post corresponding to the recipient in a digitally stored recipient database as well as to the combination of the certain posts, and is characterised in that a digitally stored rule database firstly is caused to comprise module rules, which are caused to state whether a specified module shall be comprised in a document, and field rules, which are caused to state whether a specified field shall be comprised in the specified module, and secondly is caused to be built up as an ordered tree structure, wherein each parent node comprises a module rule and wherein each subnode of each such parent node is either an additional parent node or comprises a field rule, and wherein each leaf is a field rule, in that at least one module rule is caused to state whether a specified module shall be comprised in a document based on at least one of, on the one hand, the combination of and, on the other hand, information comprised in the certain posts, in that a control means, implemented on a computer, controls a document assembly means, also implemented on the same or another computer, to produce each document for a certain combination of sender post and recipient post based on said rules by way of the control means causing the document assembly means to carry out the steps: a) obtain a next rule in the rule database according to the order of the rule database; b) if the rule is a field rule and the condition of the rule is fulfilled, enclose the field in question to the document; c) if the rule is a module rule and the condition of the rule is fulfilled, enclose the module in question to the document; d) if the rule is a module rule and the condition of the rule is not met, do not enclose neither the module in question, nor any of the modules or fields comprised in subnodes to the node in which the module rule in question is located in the tree structure, whereby the document is caused to be built up successively as a concatenation of at least one module which in turn is caused to comprise, in itself or in subnodes, at least one variable field as well as any static fields, and in that each document in the multiplicity of documents are built up in this manner for a specific combination of sender and receiver, and in that each document thereafter is sent to the recipient.

In the following, the invention will be described in closer detail, with reference to exemplifying embodiments of the invention and to the appended drawings, in which:

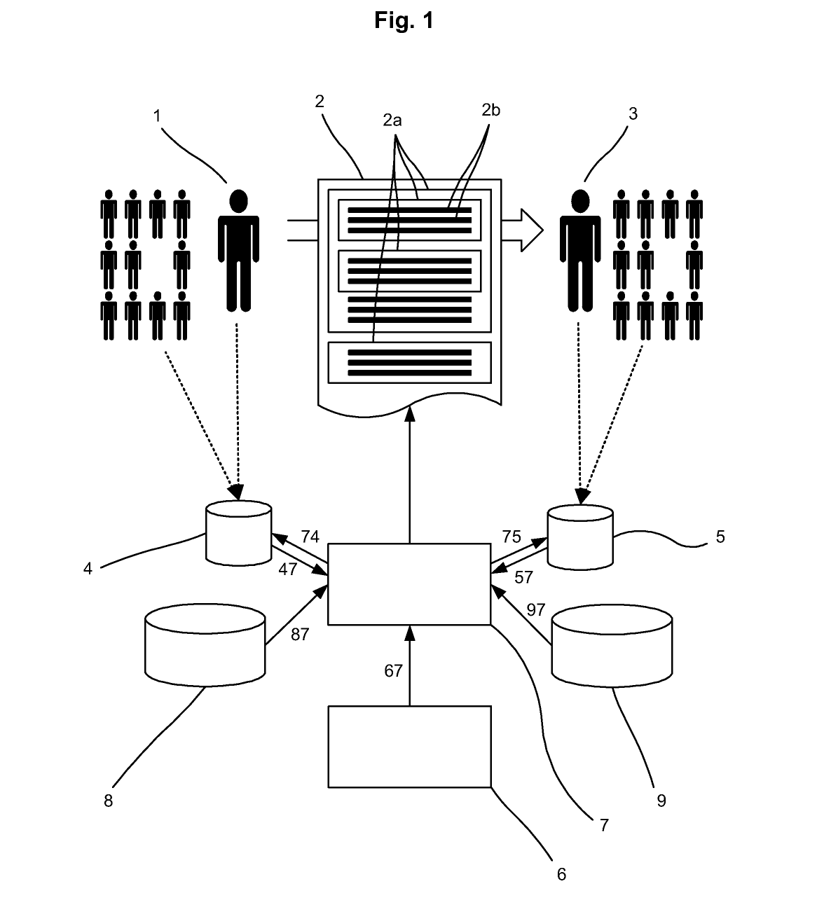

FIG. 1 is an overview of a system for carrying out a method according to the present invention.

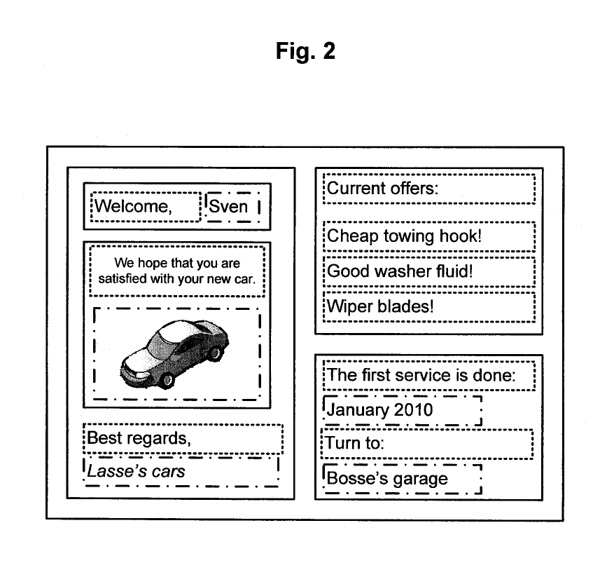

FIG. 2 is a view of an example of a document which has been produced by the use of a method according to the present invention.

FIG. 1 illustrates a document 2 which has been created in order to be communicated from a sender 1 to a recipient 3. The document 2 may be in the form of printed matter, such as a letter or a brochure, in the form of a sound file, for example for communication over a telephone network, or in electronic form, such as an e-mail, an SMS or MMS message, or an digitally stored sound file or a file comprising a graphical presentation.

The sender 1 is only one sender or may consitute one of a plurality of senders. The recipient 3 is always part of a multiplicity of recipients. In order to benefit maximally from the advantages of the invention, the number of recipients is preferably at least 100. More preferably, the number of recipients is at least 5 000. However, the number of recipients may also be substantially more than 50 000.

Information regarding each sender 1 is stored digitally, in the form of one individual post or in any other suitable and in itself conventional way, in a sender database 4. Similarly, information concerning each recipient 3 is stored digitally in a recipient database 5. Information being stored regarding every sender and recipient, respectively, may vary across different embodiments. A typical recipient post may for example be comprised of information which commonly occurs in customer registers, such as name, address, gender, customer type, previous purchases, and so on.

The document 2 is built up by one or several modules 2a and one or several fields 2b. Each module may comprise both other modules as well as one or several fields. In other words, modules may be nested one in the other. Each field may be of one of two possible types. Static fields are fields the contents of which, possibly except for formatting, are predetermined. Dynamic fields are fields the contents of which are determined at the time of assembly of the document 2. Thus, a document 2 is built up as one of one or modules 2a, in turn possibly being built up from one or several additional modules, and so on. The very contents of the document 2 are essentially constituted by the contents of the fields 2b occurring in the modules 2a, while the overarching structure of the document 2 is decided by the mutual order and nesting of the modules 2a.

A content database 8 comprises digitally stored information regarding modules 2a and fields 2b which may occur in a document 2 which is created for all possible combinations of senders 1 and recipients 3. According to a preferred embodiment, each stored module may be associated with information indicating the overarching formatting for the contents of the module, such as adjustment of text, typeface, background color, volume, effects, etc. Each stored static field is associated with certain static contents, such as a text string, graphical imagery or a sound clip. Each stored dynamical field is associated with at least a certain variable field, which also for example may be in the form of a text string, graphical imagery or a sound clip, which either is comprised in a sender post or in a recipient post. Additionally, and according to a preferred embodiment, each field may be associated with information indicating the more specific formatting for the contents of the field, in a way which is similar to the above described regarding modules.

According to a preferred embodiment, the content database 8 furthermore comprises so called global information, which is information not tied to a certain sender or to a certain recipient. Such information may, for example, be composed of the current time, interest rate, etc. Of course, such global information may, for example, also be stored in other suitable, per se conventional places and ways, or in different ways for different types of such global information.

A rule database 9 comprises digitally stored rules, in the form of module rules and field rules, respectively, controlling the assembly of a final document 2.

A module rule states a condition for if a certain specified module, which is comprised in the content database 8 and associated with the rule in question, shall be comprised in the final document 2. The condition may be based fully or partially on for which specific combination of sender 1 and recipient 3 the document 2 is being produced, and/or on specific information comprised in a certain sender- or recipient post, such as for example if the sender is a certain type of sender, if the recipient belongs to a certain geographical market segment and/or the gender of the recipient. Moreover, the condition may according to a preferred embodiment be based upon the contents of one or several global pieces of infomation.

In a similar way, a field rule states a condition for if a certain specified static or dynamic field, which is comprised in the content database 8 and is associated with the rule in question, shall be comprised in the final document 2. The condition may be of a type similar to the one for module rules.

A control means 6 controls a document assembly means 7 to produce one or several documents 2, where each document is associated with a certain specific combination of sender 1 and recipient 2. The document assembly means 7 produces each document built up as a concatenation of one or severl modules 2a, as described above.

All associations between for example rules and information, modules, conditions, fields and so on take place in a way which is in itself conventional, for example by the aid of a naming standard for various components which is consequent and uniform during the whole process.

According to an especially preferred embodiment, the rules in the rule database 9 are organised in the form of an ordered tree. By this is meant that the rule database 9 comprises a tree structure, wherein each parent node is constituted by a module rule, and wherein each subnode or child node, that is each other node which is connected to the parent node in question and positioned at a greater distance from a root node, is either constituted by another module rule or by a field rule. Furthermore, according to this embodiment each leaf node, that is each node or subnode which itself lacks subnodes, is constituted by a field rule. That the tree structure is “ordered” is to be construed so that the mutual order between the subnodes of a certain node is a certain predetermined order, which order is defined in the rule database 9 for each node in the tree structure.

When such an ordered tree structure is used, the structure itself of the rules in the rule database 9 will define the structure and order for the contents that potentially may occur in a document from a certain sender to a certain recipient, for all senders and all recipients in the respective databases 4, 5. This is achieved by the document assembly means 7 traversing the tree structure in the predetermined order, starting from a certain root node. For each subnode, it is determined whether the condition for the module or field rule present in the subnode is fulfilled. If such is the case, either, in case it is a module rule, the modul in question is enclosed, or, in case it is a field rule, the field in question is enclosed, at the end of the document 2. Thereafter, this process continues until the whole tree structure has been traversed. The expression “to traverse” a tree structure is herein meant to refer to the traversal of every node in a tree structure by following the connections between the nodes. The traversal is always carried out depth first, whereby the traversal keeps on going to ever lower subnodes until a leaf is reached, before traversal of the rest of the subnodes takes place.

Thus, a modul in a final document may constitute a part of another module. This is shown in the rule database 9 by the module rule stating the condition for the parent module constituting a parent node the subnode of which is constituted by the module rule stating the condition for the child node. It is realised that a certain module also may occur in several different module rules in the tree, and possibly with different conditions.

According to a preferred embodiment, the tree structure comprises a certain root node, which is constituted by a module rule with a certain condition. In other words, in case the condition is not met during traversal of the tree structure, none of the subnodes of the certain root node will be searched, and the document will be empty. In this case, the document assembly means 7 will interpret this as if the document will not at all be created for the current combination of sender and recipient.

According to another preferred embodiment, the tree structure comprises a number of such root nodes. In this case, each such root node is associated with its own, independent document, and thus none, one or several of the independent documents may be created for the current combination of sender and recipient.

According to the invention, each document 2 is built up from at least one module 2a, and each such module is built up from at least one variable or static field 2b. Moreover, at least one of the modules 2a comprised in the document 2 comprises a variable field. In other words, the ordered tree structure of the rule database comprises at least one node which is constituted by a module rule associated with a certain module, and each node which is constituted by a module rule has at least one subnode which is constituted by a field rule associated with either a static or dynamic field. Also, at least one node is constituted by a module rule the subnodes of which comprises at least one node which is constituted by a field rule associated with a dynamic field.

Furthermore, according to the invention the rule database 9 comprises at least one rule which at least indicates part of the contents of the final document, that is, at least one of the subnodes of the node associated with the rule in question is constituted by a field rule, based upon a certain combination of and/or information comprised in a sender post and a recipient post, respectively.

During operation, the control means 5 thus controls the document assembly means 7 to produce one or several documents 2 based upon one or several combinations of a sender 1 and a recipient 3. The document assembly means 7 puts the document 2 in question together by receiving rules from the rule database 9 and by treating these in the above described order and structure. For each rule, its associated condition is assessed from the point of view of the current combination of sender 1 and recipient 3, as well as the contents in the post associated with the current sender 1 in the sender database 4 and the contents of the post associated with the current recipient 3 in the recipient database 4, both of which posts are received from the respective database, and also any additional, global information, as has been described above. In case the condition for the rule is met, the document assembly means 7 encloses the information and/or formatting, which is stated in the rule or the module or the field associated with the rule, to the document, so that the latter is built up piece by piece in accordance with the structure and order which is indicated in the rule database 9 and with the contents and the formatting indicated in the content database 8.

According to a preferred embodiment, at least one variable field in the content database 8 comprises a piece of information which is specific for the current sender, such as its name, a piece of information which is specific for the current recipient, or a combination thereof.

According to a preferred embodiment, the control means 6 controls the document assembly means 7 to realize the above described production method for each possible combination of sender and recipient each time. The number of possible combinations of senders and recipients may in this respect be limited by beforehand ruling out some combinations of senders and recipients, for example by only allowing combinations of senders and recipient where both reside in the same geographical area, based upon the contents of the databases 4, 5.

According to a preferred embodiment, one or several nodes, specifically one or several root nodes, may be constituted by module rules, the conditions of which state that the module at hand shall only be enclosed in case the module has not already been enclosed for the current recipient 3. In other words, the post in the recipient database 5 for the current recipient 3 comprises information regarding if the module in question already has been enclosed in a document for this specific recipient 3. Namely, in this case the document assembly means 7 updates the post for the current recipient 3 in connection to the enclosure of the module in question. This way, during repeated traversals of the tree structure in the rule database 9 at the times for consequent operations, a certain document, the root node of which is constituted by the module in question, will only be communicated to the current recipient 3 at the first time of operation, and as a result the recipient 3 will only receive the document once. The corresponding may of course be true for the current sender 1, or to the current combination of sender 1 and recipient 3.

According to an especially preferred embodiment, the control means 6 is caused to communicate a document 2 to the current recipient 3 once the document assembly means 7 has finished the document 2 in question. It is preferred that this takes place essentially immediately. In the case when the document 2 is a letter, this may mean that the letter is sent the same day, together with other letters that have been produced the same day. In the case of completely electronic documents, such as e-mails, SMS or MMS messages, this may mean that the document 2 is sent essentially immediately after it has been produced. The communication may be taken care of by the document assembly means 7 itself, by the control means 6 or by another suitable and per se conventional means that is suited for this purpose.

The sender database 4, recipient database 5, content database 8, rule database 9, control means 6 and document assembly means 7 are comprised of integrated or stand-alone means implemented digitally on one or several, interconnected, computers. According to an especially preferred embodiment, all databases and means are digitally implemented on one and the same computer. The method is carried out in its entirety automatically by the computer or by the interconnected computers.

In the following, it is described how a specific document, illustrated in FIG. 2, is assembled by the use of a method according to the present invention for a certain combination of a sender 1 and a recipient 3.

In this example, the content database 8 comprises modules and fields according to Table 1. References to information in other databases are shown within brackets.

TABLE 1

| Type | Name | Contents |
|---|---|---|
| Module | Document | Columns |
| Module | Welcomepage | Left aligned |
| Module | Welcomemessage | Running |
| Module | Welcome_newcar | Centered |
| Module | Welcome_usedcar | Centered |
| Module | Current_offers_newcar | Left aligned |
| Module | Current_offers_usedcar | Left aligned |
| Module | First_service | Left aligned |
| Module | Next_service | Left aligned |
| Field | Welcome | “Welcome, ” |
| Field | Customer_firstname | [recipient→firstname] |
| Field | Welcome_newcar | “We hope that you are satis- |
| | | fied with your new car.” |
| Field | Welcome_usedcar | “We hope that you are satis- |
| | | fied with your car.” |
| Field | Picture_car | [recipient→picture_car] |
| Field | Best_regards | “Best regards,” |
| Field | Supplier_name | [sender→name], italics |
| Field | Current_offers | “Current offers:” |
| Field | Offers_towinghook | “Cheap towing hook!” |
| Field | Offers_washerfluid | “Good washer fluid!” |
| Field | Offers_wiperblades | “Wiper blades!” |
| Field | Offers_anticorrosiveagent | “Get rid of rust!” |
| Field | First_service_done | “The first service is done:” |
| Field | Next_service_done | “It is time for the next |
| | | service:” |
| Field | Datum_service | [recipient→next_service] |
| Field | Turn_to | “Turn to:” |
| Field | Service_garage | [sender→ |
| | | service_garage] |

Furthermore, the rule database 9 comprises rules according to what is shown in Table 2, in which an ordered tree structure according to the invention is illustrated as a bullet point list. Conditions are shown in brackets.

TABLE 2

[If recipient has not received Module Document]: Module
Document

[Always]: Module Welcomepage

[Always]: Module Welcomemessage

[Always]: Field Welcome
[Always]: Field Customer_firstname

[If recipient newcarcustomer]: Module Wel-
come_newcar

[Always]: Field Welcome_newcar
[Always]: Field Picture_car

[If recipient usedcarcustomer]: Module Wel-
come_usedcar

[Always]: Field Welcome_usedcar
[Always]: Field Picture_car

[Always]: Field Best_regards
[Always]: Supplier_name

[If recipient newcarcustomer]: Module Cur-
rent_offers_newcar

[Always]: Field Current_offers
[If customer does not have towing hook]: Field
Offers_towinghook
[If winter]: Field Offers_washerfluid
[Always]: Field Offers_wiperblades

[If recipient usedcarcustomer]: Module Cur-
rent_offers_usedcar

[Always]: Field Current_offers
[If winter]: Field Offers_washerfluid
[Always]: Field Offers_wiperblades
[Always]: Field Offers_anticorrosiveagent

[If recipient newcarcustomer]: Module First_service

[Always]: Field First_service_done
[Always]: Field Datum_service
[Always]: Field Turn_to
[Always]: Field Service_garage

[If recipient usedcarcustomer] : Module Next_service

[Always]: Field Next_service_done
[Always]: Field Datum_service
[Always]: Field Turn_to
[Always]: Field Service_garage

Thus, in this example the rule database 9 only comprises one root node, namely a module rule associated with the module “Document”. At one time of operation, the control means 6 controls the document assembly means 7 to traverse the tree structure in the indicated order, in this example by passing through the rules from the top down in Table 2. Thereby, the document production is commenced by the document assembly means 7 receiving the root module rule from the rule database 9, and it thereafter investigates whether the condition of the rule is met. According to Table 2, the condition reads “If recipient has not received Module Document”, which condition refers to a specific information in the current recipient's post, which for this purpose is obtained from the recipient database 5. In this case, what is observed is an initial operation, why this condition is fulfilled—the current recipient has not, in other words, earlier received a document comprising the module denoted “Document” in the content database 8. Therefore, this module is enclosed in the document, which in this case means that the document assembly means 7 receives the module denoted “Document” from the content database 8, and applies the formatting which is stated in the module, that is it formats the document in columns, in this case a left- and a right hand column. Thereafter, the traversal of the rule tree continues according to Table 2. If the condition had not been met, no document would have been created at all for this particular combination of sender 1 and recipient 2.

The next node in the tree is a module rule whose condition always is met. Therefore, the module “Welcomepage” is enclosed, which means that the contents of the document are to be left aligned, according to Table 1. In this example, this means that the contents of the current column are to be left aligned. On the other hand, it is fully possible that formatting instructions of child nodes may override or be combined with the formatting instructions of parent nodes in other ways. It is preferred that formatting instructions of child nodes are either nested, whereby the formatting instruction of a child node are only used in the local context of the child node, or that they override formatting instructions of parent nodes.

The module “Welcomepage” is thus enclosed in the document inside the module “Document”, which is illustrated in FIG. 2, where nested modules are symbolically depicted using rectangles with unbroken lines inside other rectangles with unbroken lines. However, it is realised that these rectangles are not generally written out in a finished document, but are only shown in FIG. 2 for clarity.

Thereafter, the module “Welcomemessage” is enclosed in the corresponding manner, nested inside the module “Welcomepage”. As traversal continues, thereafter two fields are enclosed in the module “Welcomepage”, namely “Welcome” and “Customer_firstname”. According to Table 1, the field “Welcome” is a static text string with the contents “Welcome,”, and without any special formatting instruction. The latter generally means that the text is enclosed using the standard formatting or alternatively the latest used formatting or the formatting used inside the current module. The field “Customer_firstname” is a dynamic field, containing the first name of the recipient, which is illustrated in Table 1 by the text “[customer→firstname]”, and is to be construed as a reference to the current recipient post obtained from the recipient database 5 by the document assembly means 7. FIG. 2 shows that this field is filled out with the text “Sven”, as this is the name of the current recipient 3 according to the recipient database 5.

Thereafter, the document assembly means 7 has reached the end of the module “Welcomemessage”, and traversal continues within the module “Welcompage”, now with the module “Welcome_newcar”. The condition for this module is that the recipient is to be a new car customer, which is fulfilled in this exemplifying case. Thus, the module “Welcome_newcar” is enclosed, using the formatting instruction centred text. Continued traversal results in the enclosure of a static field “Welcome_newcar” as well as a dynamic field “Picture_car”, filled out with the corresponding picture [recipient→picture_car] from the current post in the recipient database 5. The module “Welcome_usedcar” is not enclosed to the document 2, since the customer in this example is a new car customer.

Further traversal gives that the module “Welcomepage” is also to be enclosed the static field “Best_regards” and the dynamic field “Supplier_name”. The latter is filled out using information obtained from the current post in the sender database 4, and is in this case “Lasse's cars”. The extra formatting instruction in the field gives that the text should locally be in italics, which is also clear from FIG. 2.

With that, the end has been reached of the module “Welcomepage”. Further traversal gives the enclosure of the module “Current_offers_newcar”, containing a left alignment formatting instructions as well as the static fields “Current_offers”, “Offer_towinghook” and “Offer_wiperblades”. The field “Offer_towinghook” is associated with the condition that the recipient does not already have a towing hook on his or her car, a piece of information which is stored in the current post and in this case indicates that the customer does not have a towing hook. The field “Offers_washerfluid” is associated with the condition that it is only to be enclosed if the current season is winter. In other words, here a piece of global information is used indicating the time of year, which is stored in and obtained from the content database 8 by the document assembly means 7. The module “Current_offers_usedcar” is, to the contrary, completely skipped.

From Table 2 it is clear that several of the fields, for example the field “Offers_washerfluid”, are associated with more than one node in the rule tree. Despite this fact, each field only occurs once in the information database 8, which is clear from Table 1.

Correspondingly, the traversal thereafter continues, whereby the module “First_service” is enclosed to the document, which comprises as well static as dynamic fields associated with information from both the sender database 4 and the recipient database 5.

It may also be the case that a condition associated with a module- or field rule is based upon data from both the current sender post and the current recipient post, alternatively based upon the specific combination of sender and recipient, as well as possibly upon global information, for example comprising a register over a number of specific combinations of senders and recipients or the like.

Thus, through the above described method a number of advantages are attained in comparison to earlier methods for the production of documents for communication from a sender to one of a multiplicity of recipients.

Firstly, the selection of the target group is carried out at the very time of operation, by one or more root modules indicating which documents that should not at all be created since the current recipient falls outside of the target group. In other words, a selection does not need to be made manualy, but may be made automatically based upon conditions given in the root modules. Hence, it suffices to define one or several such root modules in order for one or several, separate or overlapping, target groups to be automatically treatable using the method according to the present invention. Thereafter, additions, removals and alterations in for example the recipient database will automatically bring with them changes in the resulting set of recipients in a certain target group, without any need for further updating special target group registers, etc. By using conditions of the type “only if the recipient has not already gotten this module”, described in detail above, the method may be carried out repeatedly, even continuously, without any one recipient receiving more than one document. Alternatively, a time aspect may be used in combination with this condition, so that a recipient receives a certain document “only if more than 1 month has passed since the recipient last got” the module, or the like, in case periodically distributed documents are desired.

Secondly, it is possible to obtain fully personalised documents, without having to use template documents that by necessity are kept quite general. This goal may be reached without having to create or maintain a plurality of different templates, since the document itself is created in its entirety at the very moment of assembly. The information from which the contents of the document are built up is found in sender and recipient databases, respectively, as well as in the content database. Each specific piece of information only occurs in one single place in these databases, why an update of for example a wording affecting many different documents only requires updating of one single text string in one single place in order to henceforth impact every document produced. This is not the case with the conventional technology. Moreover, the structure of one or several types of documents may change or be created quickly and simply, by changing the rules of the rule database and its tree structure. For example, individual modules may be added to or removed from documents, the ordering may be altered, new documents be created based upon already existing contents in other types of documents, and so forth.

Thirdly, the complexity does not increase even when produced documents are being individually tailored to the actual sender, since such an adaptation takes place in the same manner as adaptations to specific recipients.

Using the method according to the present invention, the complexity and cost for the setup and administration of rules and contents do not grow exponentially but linearly, which as opposed to conventional methods provides for very high adaptability of produced documents without unreasonable workload and cost.

Also, it is very simple to provide a sender, who orders a supplier to produce and distribute documents using the method according to the present invention, with the possibility to gain insight in and/or affect the way, when and for which recipients and/or senders documents are to be produced. By way of example, this provision may take place by the sender being offered an interface, for example via a conventional Internet site, whereby the contents of the rule database may be modified.

Above, preferred embodiments have been described. However, it is apparent for the person skilled in the art that many modifications may be made to the described embodiments without departing from the thought of the invention. Thus, the invention shall not be limited to the described embodiments, but is variable within the scope of the appended claims.

1-18. (canceled)

19. Method for the automatic production of a multiplicity of documents, where each single document (2) is intended to be communicated from a sender (1) to one (3) of a multiplicity of recipients and where the contents of the document (2) comprise data from a digitally stored content database (8) caused to comprise modules and fields, and where the contents of the document (2) furthermore are specifically adapted to information which is stored in a certain post corresponding to the sender (1) in a digitally stored sender database (4) and to information which is stored in a certain post corresponding to the recipient (3) in a digitally stored recipient database (5) as well as to the combination of the certain posts, characterised in that a digitally stored rule database (9) firstly is caused to comprise module rules, which are caused to state whether a specified module shall be comprised in a document (2), and field rules, which are caused to state whether a specified field shall be comprised in the specified module, and secondly is caused to be built up as an ordered tree structure, wherein each parent node comprises a module rule and wherein each subnode of each such parent node is either an additional parent node or comprises a field rule, and wherein each leaf is a field rule, in that at least one module rule is caused to state whether a specified module shall be comprised in a document (2) based on at least one of, on the one hand, the combination of and, on the other hand, information comprised in the certain posts, in that a control means (6), implemented on a computer, controls a document assembly means (7), also implemented on the same or another computer, to produce each document (2) for a certain combination of sender post and recipient post based on said rules by way of the control means (6) causing the document assembly means (7) to carry out the steps:
a) obtain a next rule in the rule database (9) according to the order of the rule database (9);
b) if the rule is a field rule and the condition of the rule is fulfilled, enclose the field in question to the document (2);
c) if the rule is a module rule and the condition of the rule is fulfilled, enclose the module in question to the document (2);
d) if the rule is a module rule and the condition of the rule is not met, enclose neither the module in question, nor any of the modules or fields comprised in subnodes to the node in which the module rule in question is located in the tree structure,
whereby the document (2) is caused to be built up successively as a concatenation of at least one module which in turn is caused to comprise, in itself or in subnodes, at least one variable field as well as any static fields, and in that each document in the multiplicity of documents is built up in this manner for a specific combination of sender (1) and receiver (3), and in that each document (2) thereafter is sent to the recipient (3).

20. Method according to claim 19, characterised in that, when enclosing a module, the formatting of the contents in that part of the document (2) which according to the rule database (9) consists of the module and its submodules is caused to be a formatting which is indicated in the module in the content database (8).

21. Method according to claim 19, characterised in that, when enclosing a field, firstly the information which is stated in the field in the content database (8), secondly any formatting information specified in the field and concerning the contents of that part of the document (2) which consists of the field, is enclosed to the document (2) in the current module.

22. Method according to claim 19, characterised in that each static field is caused to consist of a text passage, a piece of graphics, a sound or a combination thereof.

23. Method according to claim 19, characterised in that at least one variable field is caused to comprise a specific sender information, a specific recipient information or a combination thereof, and in that the document assembly means (7) receives this information from a specific recipient post, a specific sender post or a combination thereof, respectively.

24. Method according to claim 19, characterised in that at least one variable field is caused to comprise a piece of global information such as today's date, and in that the document assembly means (7) receives this information from a database for global information.

25. Method according to claim 19, characterised in that each module (2a) furthermore is caused to possibly comprise information regarding the formatting in terms of typography, colour and sound for the information that may occur in the module (2a).

26. Method according to claim 19, characterised in that each field (2b) furthermore is caused to possibly comprise information regarding the formatting in terms of typography, colour and sound for the information that may occur in the field (2b).

27. Method according to claim 19, characterised in that the control means (6) is caused to control the document assembly means (7) to produce documents (2) based upon each possible combination of sender (1) and recipient (3) in the respective sender (4) and recipient (5) databases.

28. Method according to claim 27, characterised in that the sender database (4) is caused to only comprise one single sender and in that the recipient database (5) is caused to comprise a multiplicity of recipients.

29. Method according to claim 19, characterised in that the document assembly means (7) is caused to produce each document (2) so that its contents and the mutual order of its contents is determined by traversing the tree structure and enclosure to the document (2) of modules (2a) and fields (2b), respectively, in the order which is indicated by the tree structure.

30. Method according to claim 19, characterised in that one or several certain root nodes are caused to be a respective module rule, which is caused to indicate whether a certain respective root module is to be enclosed, in that each respective root module is caused to define a separate document so that one or several documents in this way may be created for each combination of recipient and sender, whereby each respective module rule thereby is caused to indicate whether such a document is to be at all created for a certain combination of recipient and sender.

31. Method according to claim 29, characterised in that only one certain root node occurs in the rule database (9).

32. Method according to claim 29, characterised in that each recipient post is caused to comprise information regarding whether a certain module has already occurred in a document produced for the recipient in question, in that a certain module rule is caused to indicate that the certain module is only to be enclosed to the document for that recipient in case the certain module has not already occurred in such a document, and in that the document assembly means (7) is caused to update the recipient post in case the certain module occurs in a document produced for the recipient in question.

33. Method according to claim 19, characterised in that the document assembly means (7) may produce documents (2) in printed form.

34. Method according to claim 19, characterised in that the document assembly means (7) may produce documents (2) in the form of e-mail messages or documents in the form of SMS or MMS messages.

35. Method according to claim 19, characterised in that the document assembly means (7) may produce documents (2) at least partially in the form of a digitally stored sound file.

36. Method according to claim 19, characterised in that the control means (6) sends a document (2) to the recipient when the document assembly means (7) has finished the document (2).
